(19) United States
(12) Patent Application Publication
(10) Pub. No.: US 2020/0410043 A1
(43) Pub. Date: Dec. 31, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kazuhiro SOGA, Kanagawa (JP)

(73) Assignee: FUJI XEROX CO., LTD., Tokyo (JP)

(21) Appl. No.: 16/665,781

(22) Filed: Oct. 28, 2019

(30) Foreign Application Priority Data
Jun. 25, 2019 (JP) 2019-117615

(51) Int. Cl. G06F 17/21; G06K 9/00

(52) U.S. Cl. CPC G06F 17/212; G06K 9/00449

(57) ABSTRACT

An information processing apparatus includes a memory and a processor. The processor is connected to the memory and configured to acquire correct recognition rates for frames corresponding to items contained in a form image from statistical data regarding results of recognition of images of contents of the frames, the statistical data including, in association with an attribute of each of the frames, a size of the frame and a correct recognition rate for the frame, the correct recognition rate indicating a percentage of correctly recognized images of contents of the frame; and perform control to change a display style of a frame for which the acquired correct recognition rate is less than or equal to a threshold among the frames on a form definition screen, the form definition screen being a screen on which the form image is defined.

### CROSS-REFERENCE TO RELATED APPLICATIONS

This application is based on and claims priority under 35 USC 119 from Japanese Patent Application No. 2019-117615 filed Jun. 25, 2019.

### BACKGROUND

### (i) Technical Field

The present disclosure relates to an information processing apparatus and a non-transitory computer readable medium.

### (ii) Related Art

For example, Japanese Patent No. 4347677 describes a form OCR program that causes a computer to execute form OCR processing to recognize characters in fill-in fields on a form image that is obtained by reading a document form having arranged therein the fill-in fields for a plurality of items and pre-printed item names such that the fill-in fields and the item names are delimited by lines. The form OCR program includes an entire OCR processing step of executing OCR processing on the entire surface of the form image to recognize the positions of data input frames that define the fill-in fields, the positions of item name frames within which the item names are displayed, and character strings in these frames, and aggregating the recognized information into a single record on a frame-by-frame basis. The form OCR program further includes a fill-in field identifying step. In the fill-in field identifying step, a record corresponding to an item name for which re-OCR processing is required is read by referring to re-OCR designation information that defines in advance, for each item name, whether re-OCR processing is required. In addition, a fill-in field to be subjected to re-OCR processing is identified from the position of the item name frame included in the read record by referring to fill-in field position information that defines in advance, for each item name, a relative positional relationship with the associated fill-in field. The form OCR program further includes a partial OCR processing step. In the partial OCR processing step, partial OCR processing is executed on the fill-in field identified in the fill-in field identifying step by using dictionary data that matches the attribute of the target fill-in field on the basis of pre-defined character attribute information of each item.

Japanese Unexamined Patent Application Publication No. 7-160802 describes an OCR form template creation processing apparatus that is used to enter character information or the like for OCR reading. The OCR form template creation processing apparatus includes first means for providing data indicating constraints of a form template in accordance with the target OCR device, second means for receiving input of information that defines a desired detailed form template, and third means for making an error check of whether received detailed template defining information satisfies the constraints.

### SUMMARY

A form includes, for each item, a frame to be filled in by a person. If the frame is too small in size for the person to fill in with characters, erroneous recognition is likely to occur during OCR processing, which may result in the characters being recognized with low accuracy. However, when a form including frames is defined, a frame whose content will be recognized with low accuracy due to the size of the frame is difficult to identify in advance.

Aspects of non-limiting embodiments of the present disclosure relate to an information processing apparatus and a non-transitory computer readable medium that enable a user to identify in advance, when a form including frames is defined, a frame whose content will be recognized with low accuracy due to the size of the frame.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a memory and a processor. The processor is connected to the memory and configured to acquire correct recognition rates for frames corresponding to items contained in a form image from statistical data regarding results of recognition of images of contents of the frames, the statistical data including, in association with an attribute of each of the frames, a size of the frame and a correct recognition rate for the frame, the correct recognition rate indicating a percentage of correctly recognized images of contents of the frame; and perform control to change a display style of a frame for which the acquired correct recognition rate is less than or equal to a threshold among the frames on a form definition screen, the form definition screen being a screen on which the form image is defined.

### BRIEF DESCRIPTION OF THE DRAWINGS

Exemplary embodiments of the present disclosure will be described in detail based on the following figures, wherein:

FIG. 1 illustrates an example configuration of an information processing system according to a first exemplary embodiment;

FIG. 2 is a block diagram illustrating an example electrical configuration of a server apparatus according to the first exemplary embodiment;

FIG. 3 is a block diagram illustrating an example functional configuration of the server apparatus according to the first exemplary embodiment;

FIG. 4 is a front view illustrating an example of a form definition screen according to exemplary embodiments;

FIG. 5 illustrates an example of statistical data according to the exemplary embodiments;

FIG. 6 is a flowchart illustrating an example flow of a validation process performed in accordance with a validation process program according to the first exemplary embodiment;

FIG. 7 is a flowchart illustrating an example flow of a form setting process performed in accordance with the validation process program according to the first exemplary embodiment;

FIG. 8 is a front view illustrating another example of the form definition screen according to the exemplary embodiments;

FIG. 9 is a front view illustrating still another example of the form definition screen according to the exemplary embodiments;

FIG. 10 is a front view illustrating still another example of the form definition screen according to the exemplary embodiments;

FIG. 11 is a front view illustrating still another example of the form definition screen according to the exemplary embodiments;

FIG. 12 is a block diagram illustrating an example functional configuration of a server apparatus according to a second exemplary embodiment;

FIG. 13 is a flowchart illustrating an example flow of a form setting process performed in accordance with a validation process program according to the second exemplary embodiment; and

FIG. 14 is a front view illustrating still another example of the form definition screen according to the exemplary embodiments.

### DETAILED DESCRIPTION

The following describes exemplary embodiments of the present disclosure in detail with reference to the drawings.

### First Exemplary Embodiment

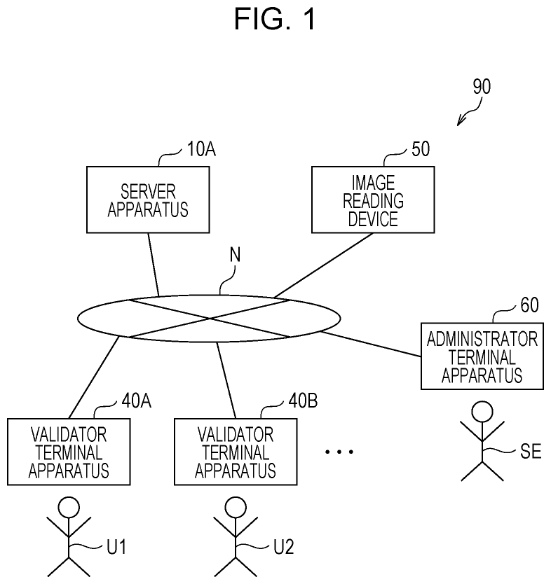

FIG. 1 illustrates an example configuration of an information processing system 90 according to a first exemplary embodiment.

As illustrated in FIG. 1, the information processing system 90 according to this exemplary embodiment includes a server apparatus 10A, validator terminal apparatuses 40A, 40B, etc., an image reading device 50, and an administrator terminal apparatus 60. The server apparatus 10A is an example of an information processing apparatus.

The server apparatus 10A is connected so as to be capable of communicating with the validator terminal apparatuses 40A, 40B, etc., the image reading device 50, and the administrator terminal apparatus 60 via a network N. Examples of the server apparatus 10A include a server computer and a general-purpose computer such as a personal computer (PC). Examples of the network N include the Internet, a local area network (LAN), and a wide area network (WAN).

The image reading device 50 has a function of optically reading a document such as a paper form to obtain an image and transmitting the obtained image (hereinafter referred to as the “form image”) to the server apparatus 10A. The term “form”, as used herein, refers to any of various document forms containing a plurality of fields of items such as name and address fields. In the form, each of the plurality of fields of items is filled out with handwritten characters, printed characters, or the like. Specifically, as described below, the server apparatus 10A performs optical character recognition (OCR) processing on the form image received from the image reading device 50 and acquires a recognition result of an image corresponding to each of the plurality of fields of items. Examples of the recognition result include a character string indicating a sequence of characters containing one or more letters and numbers. In the form, areas to be filled in, which correspond to the fields of items, are bounded by frames or the like, and the areas to be filled in are defined as areas to be subjected to recognition. OCR processing is performed on the defined areas to acquire character strings for the respective images corresponding to the plurality of fields of items.

The validator terminal apparatus 40A is a terminal apparatus operated by a validator (user) U1 who performs a validation operation, and the validator terminal apparatus 40B is a terminal apparatus operated by a validator U2 who performs a validation operation. The validator terminal apparatuses 40A, 40B, etc. are also referred to collectively as validator terminal apparatuses 40 or individually as validator terminal apparatus 40 unless the validator terminal apparatuses 40A, 40B, etc. need be distinguished from each other. Also, the validators U1, U2, etc. are referred to collectively as validators U or individually as validator U unless the validators U1, U2, etc. need be distinguished from each other. Examples of the validator terminal apparatus 40 include a general-purpose computer such as a PC and a portable terminal apparatus such as a smartphone and a tablet terminal. The validator terminal apparatus 40 has installed therein a validation application program (hereinafter referred to also as “validation application”) for allowing the validator U to perform a validation operation. The validator terminal apparatus 40 generates and displays a validation operation user interface (UI) screen. The term “validation” or “validation operation”, as used herein, refers to an operation of validating (and correcting, if any) a recognition result of characters or the like in the form image.

The administrator terminal apparatus 60 is a terminal apparatus operated by a system administrator SE. The system administrator SE configures form definition data through a form definition screen described below. Examples of the administrator terminal apparatus 60 include a general-purpose computer such as a PC and a portable terminal apparatus such as a smartphone and a tablet terminal.

The form image includes sub-images of fields of items (hereinafter referred to as “item images”), and each of the item images is recognized to obtain a recognition result. If the recognition result has a confidence level less than a threshold, the server apparatus 10A makes a person manually validate the recognition result. If the recognition result has a confidence level greater than or equal to the threshold, the server apparatus 10A outputs the recognition result as a final recognition result without performing any manual validation operation.

To perform the validation operation described above, the server apparatus 10A performs control to display each of the item images and a character string obtained by OCR processing on the UI screen of the validator terminal apparatus 40 in association with each other. The validator U views each of the item images and validates whether the character string corresponding to the item image is correct. As a result of the validation, if the character string is correct, the validator U performs no operation, and if the character string is not correct, the validator U inputs a correct character string on the UI screen. The validator terminal apparatus 40 transmits the character string whose input is received on the UI screen to the server apparatus 10A as a validation result. The server apparatus 10A outputs a final recognition result based on the validation result from the validator terminal apparatus 40, and performs control to display the final recognition result on the UI screen of the validator terminal apparatus 40.

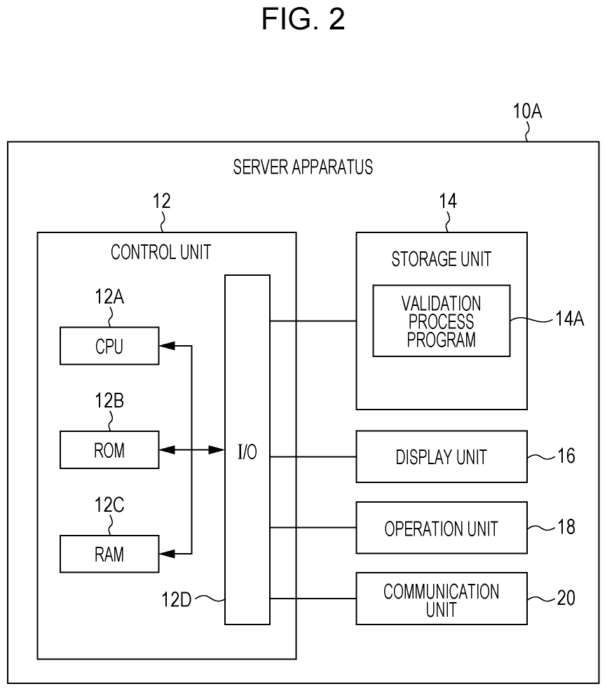

FIG. 2 is a block diagram illustrating an example electrical configuration of the server apparatus 10A according to the first exemplary embodiment.

As illustrated in FIG. 2, the server apparatus 10A according to this exemplary embodiment includes a control unit 12, a storage unit 14, a display unit 16, an operation unit 18, and a communication unit 20.

The control unit 12 includes a central processing unit (CPU) 12A, a read only memory (ROM) 12B, a random access memory (RAM) 12C, and an input/output interface (I/O) 12D. The CPU 12A, the ROM 12B, the RAM 12C, and the I/O 12D are interconnected via a bus.

The I/O 12D is connected to functional units including the storage unit 14, the display unit 16, the operation unit 18, and the communication unit 20. Each of the functional units is capable of communicating with the CPU 12A via the I/O 12D.

The control unit 12 may be configured as a sub-control unit that controls part of the operation of the server apparatus 10A, or may be configured as a main control unit that controls the overall operation of the server apparatus 10A. Some or all of the blocks of the control unit 12 are implemented using, for example, an integrated circuit (IC) such as a large scale integrated (LSI) circuit or an IC chip set. Each of the blocks may be implemented as a single separate circuit, or some or all of the blocks may be integrated on a circuit. Alternatively, the blocks may be formed into a single unit, or some of the blocks may be separately disposed. Alternatively, in each of the blocks, a portion thereof may be separately disposed. The control unit 12 may be integrated by using a dedicated circuit or a general-purpose processor instead of by using an LSI circuit.

Examples of the storage unit 14 include a hard disk drive (HDD), a solid state drive (SSD), and a flash memory. The storage unit 14 stores a validation process program 14A for performing a form validation process and a form setting process according to this exemplary embodiment. The validation process program 14A may be stored in the ROM 12B.

The validation process program 14A may be installed in the server apparatus 10A in advance, for example. The validation process program 14A may be implemented as follows. The validation process program 14A may be stored in a non-volatile storage medium or distributed via the network N and installed in the server apparatus 10A, if necessary. Possible examples of the non-volatile storage medium include a compact disc read only memory (CD-ROM), a magneto-optical disk, an HDD, a digital versatile disc read only memory (DVD-ROM), a flash memory, and a memory card.

Examples of the display unit 16 include a liquid crystal display (LCD) and an organic electroluminescent (EL) display. The display unit 16 may have a touch panel integrated therein. The operation unit 18 is provided with an operation input device such as a keyboard and a mouse. The display unit 16 and the operation unit 18 accept various instructions from the user of the server apparatus 10A. The display unit 16 displays various types of information, examples of which include results of a process executed in accordance with an instruction accepted from the user, and a notification about the process.

The communication unit 20 is connected to the network N, such as the Internet, an LAN, or a WAN, and is allowed to communicate with each of the image reading device 50, the validator terminal apparatus 40, and the administrator terminal apparatus 60 via the network N.

As described above, when a form including frames is defined, a frame whose content will be recognized with low accuracy due to the size of the frame is difficult to identify in advance.

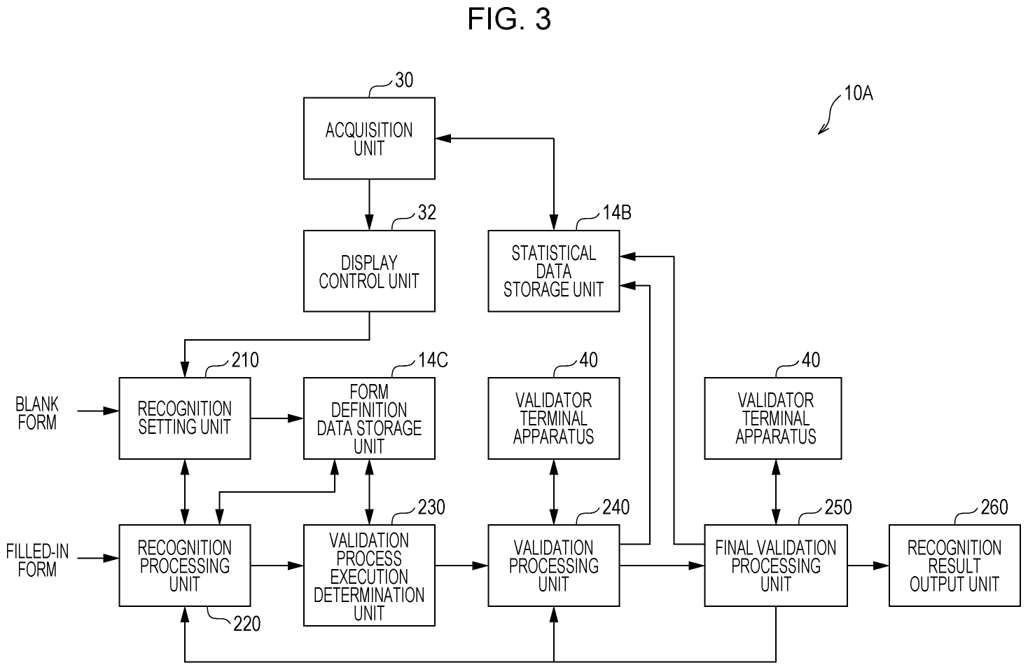

Accordingly, the CPU 12A of the server apparatus 10A according to this exemplary embodiment loads the validation process program 14A stored in the storage unit 14 into the RAM 12C and executes the validation process program 14A, thereby functioning as the components illustrated in FIG. 3. The CPU 12A is an example of a processor.

FIG. 3 is a block diagram illustrating an example functional configuration of the server apparatus 10A according to the first exemplary embodiment.

As illustrated in FIG. 3, the CPU 12A of the server apparatus 10A according to this exemplary embodiment functions as an acquisition unit 30 and a display control unit 32. The CPU 12A of the server apparatus 10A also functions as a recognition setting unit 210, a recognition processing unit 220, a validation process execution determination unit 230, a validation processing unit 240, a final validation processing unit 250, and a recognition result output unit 260.

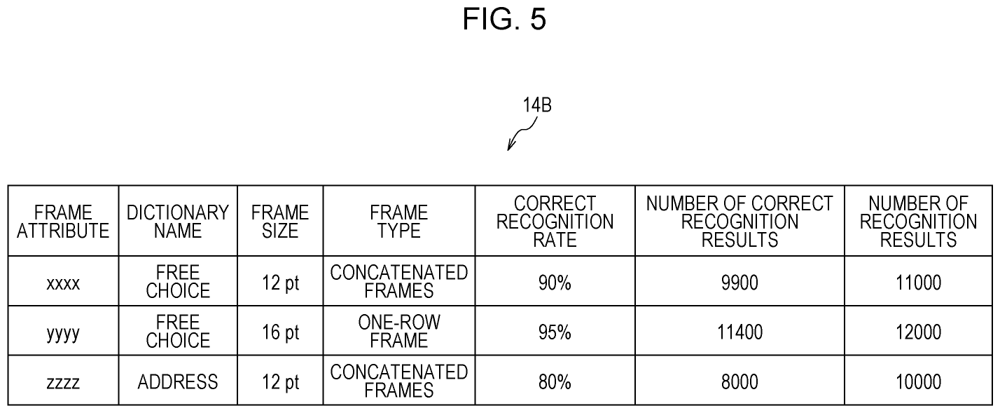

The storage unit 14 according to this exemplary embodiment includes, by way of example, a statistical data storage unit 14B that stores statistical data illustrated in FIG. 5 described below, and a form definition data storage unit 14C that stores form definition data.

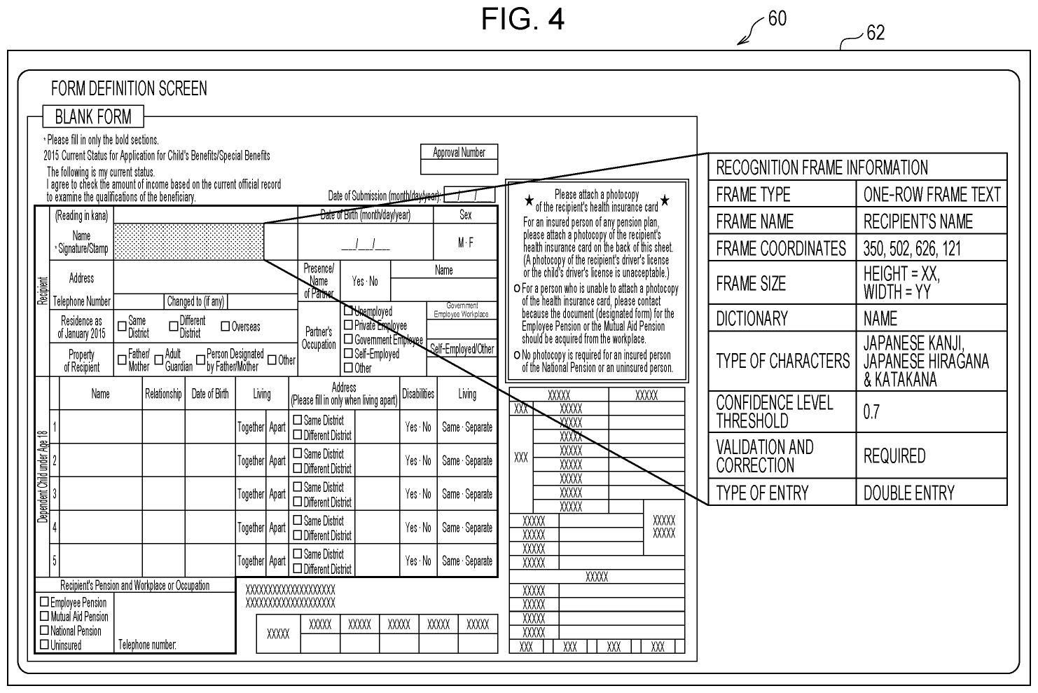

The recognition setting unit 210 receives input of a form image of a blank form and performs recognition setting. By way of example, the recognition setting unit 210 causes the administrator terminal apparatus 60 to display a form definition screen 62 illustrated in FIG. 4, and accepts input of form definition data.

FIG. 4 is a front view illustrating an example of the form definition screen 62 according to this exemplary embodiment.

The form definition screen 62 illustrated in FIG. 4 is a screen displayed on the administrator terminal apparatus 60 for accepting input of form definition data by the system administrator SE.

The form definition screen 62 illustrated in FIG. 4 includes a preview image of a blank form, and recognition frame information indicating form definition data (hereinafter referred to also as the “property information”). The recognition frame information includes, by way of example, a frame type, a frame name, frame coordinates, a frame size (frame height and width), a dictionary, a type of characters, a confidence level threshold, validation and correction, and a type of entry, and the content of the respective settings is stored in the form definition data storage unit 14C. The dictionary indicates a recognition dictionary. In the example illustrated in FIG. 4, information concerning the “recipient's name” is displayed. The confidence level is a measure of how confident the recognition result is. The higher the value of the confidence level, the higher the probability of matching between the item image and the recognition result. The confidence level may be derived by using a known method described in, for example, Japanese Unexamined Patent Application Publication No. 2016-212812. When the confidence level of each character in a character string is used, a technique for converting the confidence level of each character into the confidence level of the character string is used. Specifically, any appropriate one of the various techniques provided below may be selected.

(i) The maximum of the values of the confidence level of the characters in the character string is used as the confidence level of the character string.

(ii) The minimum of the values of the confidence level of the characters in the character string is used as the confidence level of the character string.

(iii) The mean (mode, median, or the like) of the values of the confidence level of the characters in the character string is used as the confidence level of the character string.

The validation and correction is used to set whether to perform a validation operation, and “required” or “not required” is set, by way of example. When “required” is set, a validation operation is performed each time recognition is performed. When “not required” is set, no validation operation is performed.

The type of entry is used to set the method by which a validation operation is performed. By way of example, any one of “double entry”, “single entry”, “not required”, and “no entry” is set. “Double entry” is a method in which a plurality of validators perform a validation operation, and “single entry” is a method in which a single validator performs a validation operation. “Not required” is a method in which no validation is required. “No entry” is a method in which any one of “not required”, “single entry”, and “double entry” is selected based on the result of comparison between the confidence level and the threshold (in the example illustrated in FIG. 4, “0.7”). In “no entry”, by way of example, either “single entry” or “double entry” is selected when the confidence level is less than the threshold, and “not required” is selected when the confidence level is greater than or equal to the threshold.

The dictionary is used to set a recognition dictionary for each item. In the example illustrated in FIG. 4, a recognition dictionary for “name” is set.

The recognition processing unit 220 receives input of a form image indicating a filled-in form, and executes OCR processing for each item in accordance with the content of the settings of the form definition data stored in the form definition data storage unit 14C. The recognition processing unit 220 outputs, for each item, an item image, a recognition result, and a confidence level in association with each other.

The validation process execution determination unit 230 determines a type of entry for each item on the basis of the item image, the recognition result, and the confidence level of the item, which are output from the recognition processing unit 220. For example, an item for which “single entry” or “double entry” is set as the type of entry is not subjected to threshold determination based on the confidence level. An item for which “no entry” is set as the type of entry is subjected to threshold determination based on the confidence level, and a type of entry is determined in the way described above. The validation process execution determination unit 230 outputs a determination result to the validation processing unit 240.

The validation processing unit 240 changes the type of entry for each item on the basis of the determination result accepted from the validation process execution determination unit 230, and feeds back the item image and the recognition result to the validator U to prompt the validator U to perform a validation operation. Specifically, when the type of entry of the recognition result is determined to be single entry, the validation processing unit 240 causes a single validator terminal apparatus 40 to display a validation screen for validation to prompt the validator U to perform a validation operation. When the type of entry of the recognition result is determined to be double entry, the validation processing unit 240 causes a plurality of validator terminal apparatuses 40 to display a validation screen for validation to prompt the individual validators U to perform a validation operation. The validation processing unit 240 outputs the item image, the recognition result, and the result of the validation performed by the validator(s) U to the final validation processing unit 250.

Based on the item image, the recognition result, and the result of the validation performed by the validator(s) U, which are accepted from the validation processing unit 240, the final validation processing unit 250 prompts another validator U different from the validator(s) U to perform a final validation operation. Specifically, the final validation processing unit 250 causes the validator terminal apparatus 40 used by the different validator U to display a validation screen for final validation, and obtains a final validation result from the different validator U. Based on the final validation result from the different validator U, if the result of the validation performed by the validator(s) U is wrong, the final validation processing unit 250 returns the wrong result to the validation processing unit 240. If the input filled-in form is incomplete (e.g., page missing), the final validation processing unit 250 returns the incomplete form to the recognition processing unit 220. Then, the final validation processing unit 250 outputs a final recognition result to the recognition result output unit 260.

The recognition result output unit 260 outputs the final recognition result accepted from the final validation processing unit 250. The final recognition result may be output to, for example, but not limited to, at least one of the display unit 16, the validator terminal apparatus 40, and the administrator terminal apparatus 60.

The validation result obtained by the validation processing unit 240 and the final validation result obtained by the final validation processing unit 250 are accumulated in the storage unit 14. The validation results include, for the attribute of each frame, a dictionary name, a frame size, a frame type, correct/incorrect information of a recognition result, and the like, by way of example. The correct/incorrect information is correct information indicating that a recognition result that is not corrected is determined to be correct, or incorrect information indicating that a recognition result that is corrected is determined to be incorrect. When a certain number of validation results (e.g., 10000 or more) are accumulated in the storage unit 14, by way of example, statistical data illustrated in FIG. 5 is generated and is stored in the statistical data storage unit 14B.

FIG. 5 illustrates an example of statistical data according to this exemplary embodiment.

The statistical data illustrated in FIG. 5 is data concerning recognition results for each of the frames corresponding to items contained in the form image. The statistical data is data including, in association with the attribute of each of the frames, a dictionary name, a frame size, a frame type, a correct recognition rate, the number of correct recognition results, and the number of recognition results. In this exemplary embodiment, the dictionary name is optional and may not necessarily be included. The attribute of each frame is represented by the name of the frame, such as “recipient, name”, by way of example. The number of recognition results is the number of recognition results obtained by recognizing images of contents in each frame by using OCR processing. The number of correct recognition results is the number of recognition results that are not corrected during validation. The correct recognition rate indicates the percentage of correctly recognized images of contents of each frame, and is calculated by dividing the number of correct recognition results by the number of recognition results. In this exemplary embodiment, the target is forms filled out by a specific group of people. Examples of the specific group of people include a group of people by age, a group of people by occupation, and a group of people by gender.

When a form image is defined through the form definition screen 62 illustrated in FIG. 4 described above, by way of example, the acquisition unit 30 acquires the correct recognition rate associated with the attribute of each frame from the statistical data illustrated in FIG. 5.

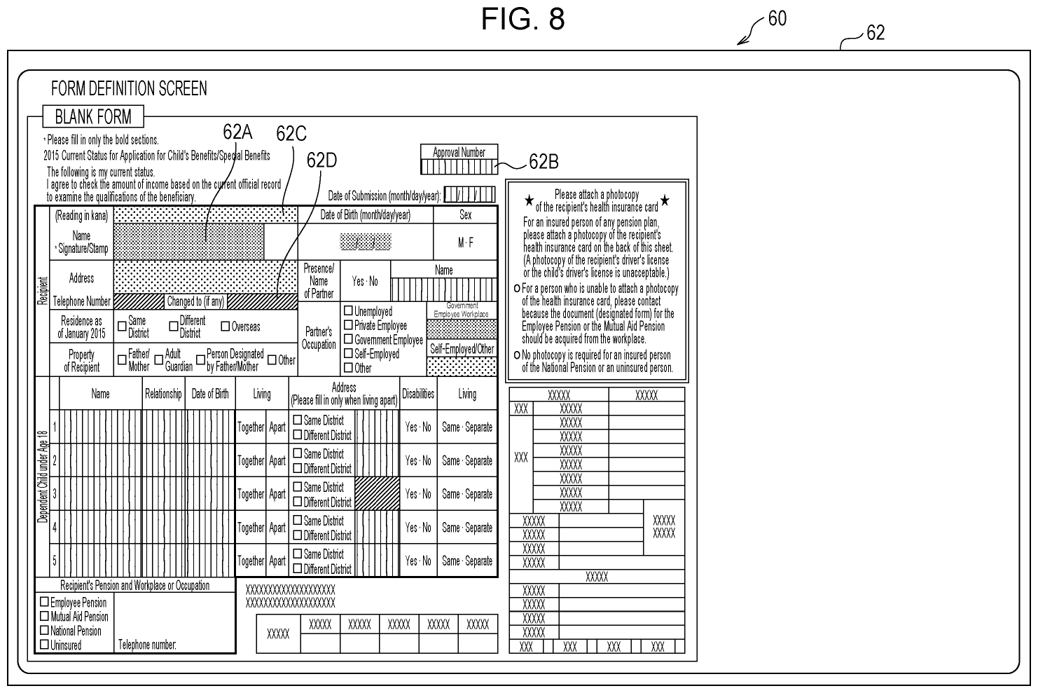

The display control unit 32 performs control to change the display style of a frame for which the correct recognition rate acquired by the acquisition unit 30 is less than or equal to a threshold on the form definition screen 62. In this case, by way of example, as illustrated in FIG. 8 described below, the display control unit 32 may perform control to change the display styles of the frames in the form image in a different manner on the form definition screen 62 in accordance with the correct recognition rates for the frames. That is, control is performed such that a frame for which the correct recognition rate is low is displayed in a different style from that of the other frames. This enables a user who defines the form image (in this exemplary embodiment, the system administrator SE) to identify the frame with a low correct recognition rate at a glance. The display style of each frame may be changed in various ways, examples of which include using different colors, applying hatching, applying shading, and adding a mark.

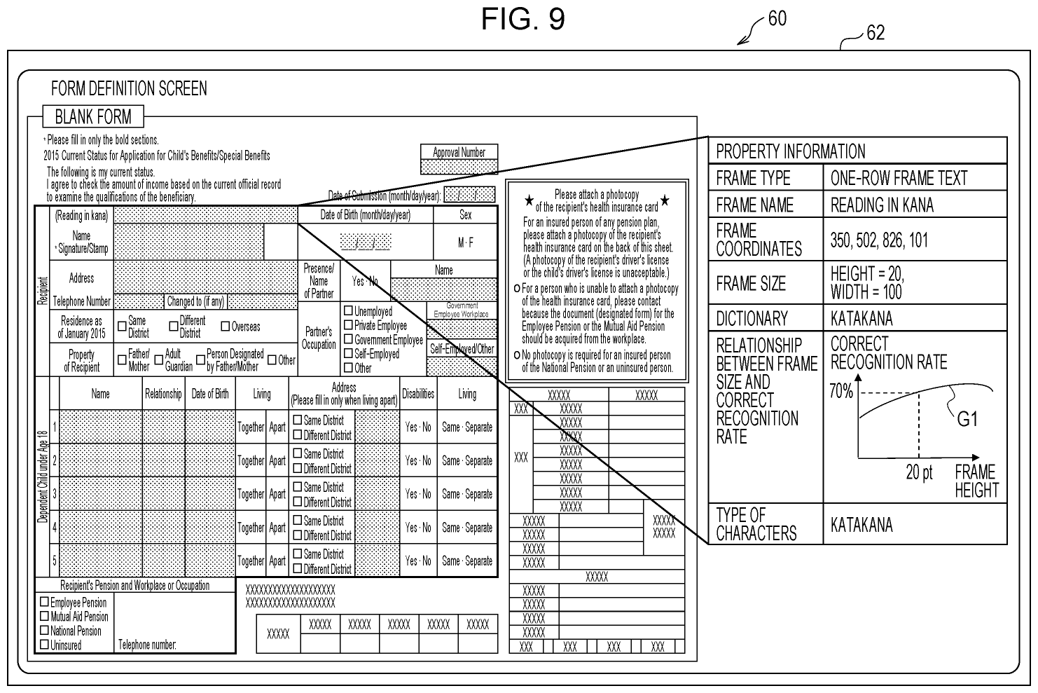

Further, the display control unit 32 may perform control to display, on the form definition screen 62, a relationship between the sizes of the frames and the correct recognition rates for the frames, which is derived from the statistical data. The relationship between the size of a frame and the correct recognition rate for the frame is represented by a graph G1 illustrated in FIG. 9 described below, by way of example.

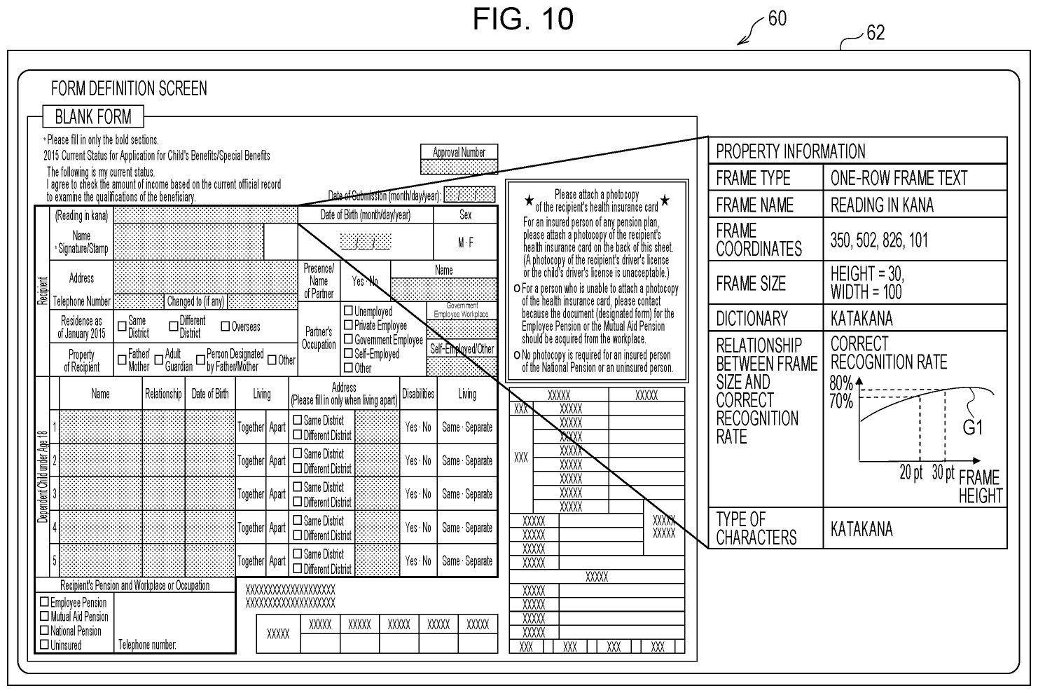

Further, in response to receipt on the form definition screen 62 of a change in the size of a frame whose display style is changed, by way of example, as illustrated in FIG. 10 described below, the display control unit 32 may perform control to display relationships between the size of the frame and the correct recognition rate for the frame, which are obtained before and after the change.

Further, the display control unit 32 may perform control to change the display style of a nearby frame located near a frame whose display style is changed, when the correct recognition rate for the nearby frame is low, the nearby frame being a frame whose size decreases with an increase in the size of the frame whose display style is changed. The nearby frame may be located adjacent to or away from the frame whose display style is changed.

Further, the display control unit 32 may perform control to change the display style of the frame having the smallest reduction in correct recognition rate among a plurality of frames other than a frame whose display style is changed, the plurality of frames being frames whose sizes decrease with an increase in the size of the frame whose display style is changed. The frame having the smallest reduction in correct recognition rate may be a frame for which the correct recognition rate does not change much, that is, a frame having the lowest rate of reduction in correct recognition rate, or may be a frame having the lowest rate of reduction in correct recognition rate and the highest correct recognition rate.

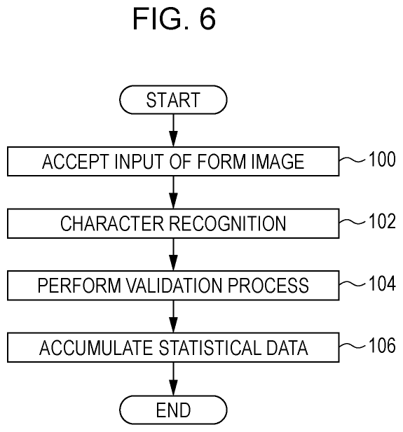

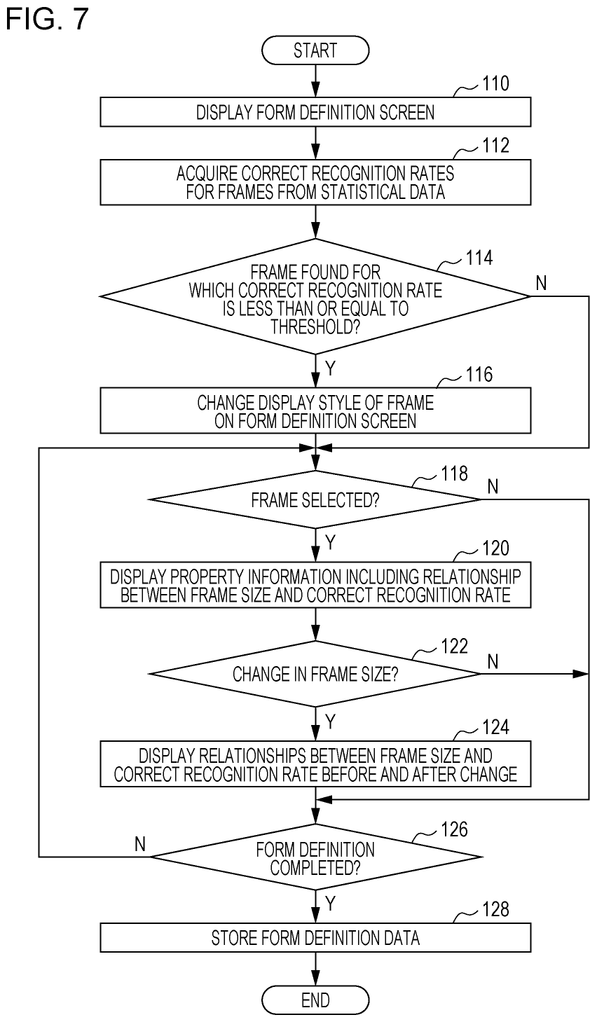

Next, the operation of the server apparatus 10A according to the first exemplary embodiment will be described with reference to FIG. 6 and FIG. 7.

FIG. 6 is a flowchart illustrating an example flow of a validation process performed in accordance with the validation process program 14A according to the first exemplary embodiment.

First, when the server apparatus 10A is instructed to execute a validation process, the validation process program 14A is started, and the following steps are executed.

In step 100 in FIG. 6, the CPU 12A, which serves as the recognition processing unit 220, accepts input of a form image.

In step 102, the CPU 12A, which serves as the recognition processing unit 220, performs character recognition on an item image for each item in the form image whose input is accepted in step 100, and acquires a recognition result.

In step 104, the CPU 12A, which serves as the validation processing unit 240 and the final validation processing unit 250, causes the validator U to perform a validation process. Specifically, as described above, the validator U views an item image displayed on the UI screen of the validator terminal apparatus 40 and validates whether the character string of the recognition result corresponding to the item image is correct. As a result of the validation, if the character string is correct, the validator U performs no operation, and if the character string is not correct, the validator U inputs a correct character string on the UI screen. The server apparatus 10A receives the character string whose input is received on the UI screen from the validator terminal apparatus 40 as a validation result.

In step 106, the CPU 12A receives the result of the validation process performed in step 104, generates, by way of example, the statistical data illustrated in FIG. 5 described above for each item in the form image, that is, for the attribute of each frame, and accumulates the generated statistical data in the statistical data storage unit 14B. Then, the validation process according to the validation process program 14A ends.

FIG. 7 is a flowchart illustrating an example flow of a form setting process performed in accordance with the validation process program 14A according to the first exemplary embodiment.

First, when the server apparatus 10A is instructed to execute a form setting process, the validation process program 14A is started, and the following steps are executed.

In step 110 in FIG. 7, the CPU 12A, which serves as the recognition setting unit 210, displays the form definition screen 62 illustrated in FIG. 4 described above on the administrator terminal apparatus 60, by way of example.

In step 112, the CPU 12A, which serves as the acquisition unit 30, acquires correct recognition rates for the attributes of the frames from the statistical data illustrated in FIG. 5 described above, by way of example.

In step 114, the CPU 12A, which serves as the display control unit 32, determines whether a frame is found for which the correct recognition rate acquired in step 112 is less than or equal to a threshold. If it is determined that a frame is found for which the correct recognition rate is less than or equal to the threshold (if positive determination is obtained), the process proceeds to step 116. If it is determined that no frame is found for which the correct recognition rate is less than or equal to the threshold (if negative determination is obtained), the process proceeds to step 118.

In step 116, the CPU 12A, which serves as the display control unit 32, performs control to change the display style of the frame whose correct recognition rate is determined in step 114 to be less than or equal to the threshold on the form definition screen 62. The CPU 12A performs control to change the display styles of the frames in the form image in a different manner on the form definition screen 62 as illustrated in FIG. 8 in accordance with the correct recognition rates for the frames, by way of example.

FIG. 8 is a front view illustrating another example of the form definition screen 62 according to this exemplary embodiment.

On the form definition screen 62 illustrated in FIG. 8, the frames are displayed in different colors in accordance with the respective correct recognition rates. In the example illustrated in FIG. 8, the difference in color is represented by a difference in hatching. For example, a first recognition frame 62A represents a frame with a correct recognition rate greater than or equal to 90% and is shown in green. The first recognition frame 62A includes “recipient, name”, “recipient, date of birth”, and “partner's occupation, government employee workplace” sections, by way of example. For example, a second recognition frame 62B represents a frame with a correct recognition rate greater than or equal to 80% and less than 90% and is shown in light blue. The second recognition frame 62B includes “approval number”, “date of submission”, “presence/name of partner, name”, “dependent child under age 18, names 1 to 5”, “dependent child under age 18, relationships 1 to 5”, “dependent child under age 18, dates of birth 1 to 5”, and “dependent child under age 18, addresses 1, 2, 4, and 5” sections, by way of example. For example, a third recognition frame 62C represents a frame with a correct recognition rate greater than or equal to 70% and less than 80% and is shown in yellow. The third recognition frame 62C includes “recipient, reading in kava” and “recipient, address” sections, by way of example. For example, a fourth recognition frame 62D represents a frame with a correct recognition rate less than or equal to 50% and is shown in red. The fourth recognition frame 62D includes “recipient, telephone number”, “recipient, changed to (if any)”, and “dependent child under age 18, address 3” sections, by way of example.

It should be understood that, by way of example, when the threshold described above is set to 50%, the color of only the fourth recognition frame 62D with a correct recognition rate less than or equal to 50% may be changed to red. Only by viewing the form definition screen 62 illustrated in FIG. 8 at a glance, the system administrator SE identifies in advance a frame whose content will be recognized with low accuracy due to the size of the frame.

In step 118, the CPU 12A, which serves as the display control unit 32, determines whether a frame is selected on the form definition screen 62 by the operation of the system administrator SE. If it is determined that a frame is selected (if positive determination is obtained), the process proceeds to step 120. If it is determined that no frame is selected (if negative determination is obtained), the process proceeds to step 126.

In step 120, by way of example, as illustrated in FIG. 9, the CPU 12A, which serves as the display control unit 32, performs control to display property information of the frame selected in step 118, which includes the relationship between the size of the frame and the correct recognition rate for the frame, on the form definition screen 62.

FIG. 9 is a front view illustrating still another example of the form definition screen 62 according to this exemplary embodiment.

On the form definition screen 62 illustrated in FIG. 9, property information is displayed. The property information includes a frame type, a frame name, frame coordinates, a frame size, dictionary, the relationship between the frame size and the correct recognition rate, and a type of characters, by way of example. The relationship between the size of a frame and the correct recognition rate for the frame is represented by a graph G1, by way of example. The graph G1 is a graph derived from the statistical data described above. In the graph G1, the horizontal axis represents the frame height, and the vertical axis represents the correct recognition rate. In the example illustrated in FIG. 9, the frame with the attribute “recipient, reading in kava” is selected, with the height of the selected frame being 20 pt and the correct recognition rate for the selected frame being 70%. In this case, a frame height of 20 pt and a correct recognition rate of 70% are plotted on the graph G1.

In step 122, the CPU 12A, which serves as the display control unit 32, determines whether a change in the size of the frame whose property information is displayed in step 120 is receipt on the form definition screen 62 illustrated in FIG. 9 described above, by way of example. If it is determined that a change in the size of the frame is received (if positive determination is obtained), the process proceeds to step 124. If it is determined that a change in the size of the frame is not received (if negative determination is obtained), the process proceeds to step 126.

In step 124, by way of example, as illustrated in FIG. 10, the CPU 12A, which serves as the display control unit 32, performs control to display the states in the graph G1 before and after the change. Here, by way of example, the frame height is changed to 30 pt.

FIG. 10 is a front view illustrating still another example of the form definition screen 62 according to this exemplary embodiment.

On the form definition screen 62 illustrated in FIG. 10, the frame height has been changed from 20 pt to 30 pt. When the frame height is changed to 30 pt, the correct recognition rate is changed to 80%. In the example illustrated in FIG. 10, while the graph G1 itself is not changed, the correct recognition rate is changed with the change in the frame height. The change in the correct recognition rate is plotted on the graph G1 so that the states before and after the change can be understood at a glance. Specifically, on the graph G1, a frame height of 20 pt and a correct recognition rate of 70% are plotted in the state before the change, and a frame height of 30 pt and a correct recognition rate of 80% are plotted in the state after the change.

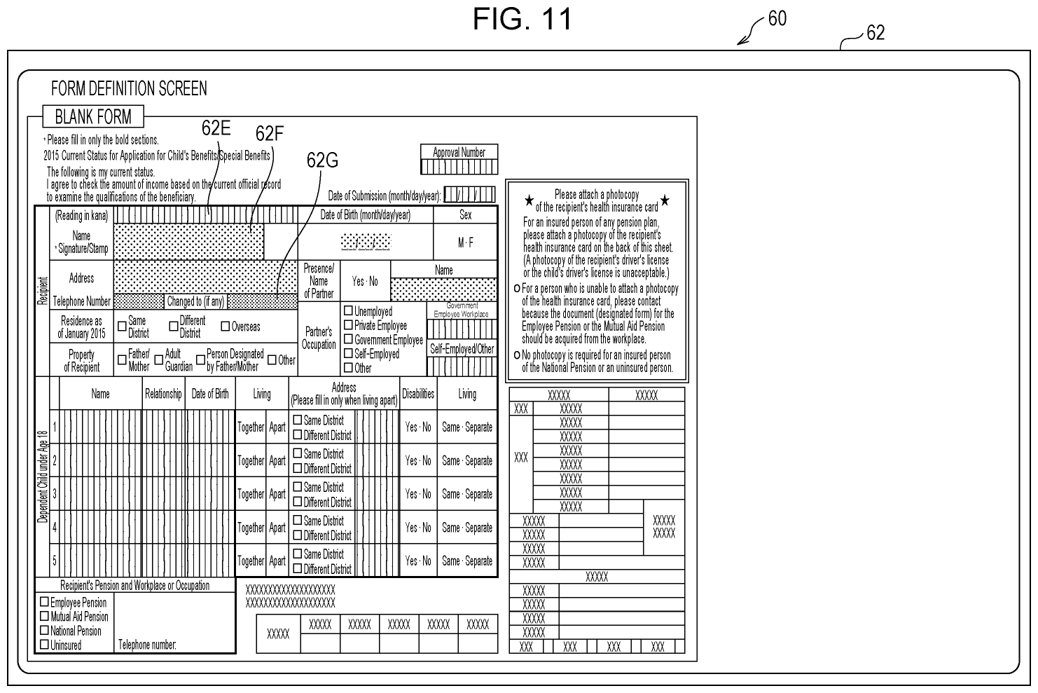

FIG. 11 is a front view illustrating still another example of the form definition screen 62 according to this exemplary embodiment.

On the form definition screen 62 illustrated in FIG. 11, as in the example illustrated in FIG. 8, the difference in color is represented by a difference in hatching. For example, a fifth recognition frame 62E represents a frame with a correct recognition rate greater than or equal to 80% and less than 90% and is shown in light blue. For example, a sixth recognition frame 62F represents a frame with a correct recognition rate greater than or equal to 90% and is shown in green. For example, a seventh recognition frame 62G represents a frame with a correct recognition rate less than or equal to 50% and is shown in red.

In this case, as described above, the CPU 12A may perform control to change the display style of a nearby frame located near a frame whose display style is changed, when the correct recognition rate for the nearby frame is low, the nearby frame being a frame whose size decreases with an increase in the size of the frame whose display style is changed. Specifically, in the example illustrated in FIG. 11, an increase in the frame height of the “recipient, telephone number” section, which is an example of the seventh recognition frame 62G, results in a reduction in the frame height of the “recipient, address” section, which is an example of the sixth recognition frame 62F and is located adjacent to the “recipient, telephone number” section. If the correct recognition rate decreases due to the reduction in the frame height of the “recipient, address” section, the color of the “recipient, address” section is changed. For example, the color of the “recipient, address” section is changed from green to a similar color such as greenish yellow. Alternatively, the color of the “recipient, address” section may be changed from green to red. The frame whose height is reduced is not limited to an adjoining frame, and may be a distant frame. That is, the target is all nearby frames whose height can be reduced due to an increase in the height of a certain frame.

Further, as described above, the CPU 12A may perform control to change the display style of the frame having the smallest reduction in correct recognition rate among a plurality of frames other than a frame whose display style is changed, the plurality of frames being frames whose sizes decrease with an increase in the size of the frame whose display style is changed. Specifically, in the example illustrated in FIG. 11, as a result of increasing the frame height of the “telephone number” section, which is an example of the seventh recognition frame 62G, the frame having the smallest reduction in correct recognition rate is assumed to be the sixth recognition frame 62F. In this case, the color of the sixth recognition frame 62F (here, green) is blinked. The blinking of color may inform the system administrator SE of which frame the system administrator SE is to reduce the height.

In step 126, the CPU 12A, which serves as the recognition setting unit 210, determines whether form definition is completed. If it is determined that form definition is completed (if positive determination is obtained), the process proceeds to step 128. If it is determined that form definition is not completed (if negative determination is obtained), the process returns to step 118, and the CPU 12A repeatedly performs the process.

In step 128, the CPU 12A, which serves as the recognition setting unit 210, stores the form definition data whose input is received on the form definition screen 62 in the form definition data storage unit 14C. Then, the form setting process according to the validation process program 14A ends.

In this exemplary embodiment, accordingly, when defining a form image, only by viewing a form definition screen at a glance, a user may identify in advance a frame whose content will be recognized with low accuracy due to the size of the frame. In addition, recognition accuracy may be improved by changing the size of the frame whose content will be recognized with low accuracy.

### Second Exemplary Embodiment

In the first exemplary embodiment described above, the size of a frame is changed to improve recognition accuracy. In a second exemplary embodiment, a recognition dictionary is changed to improve recognition accuracy.

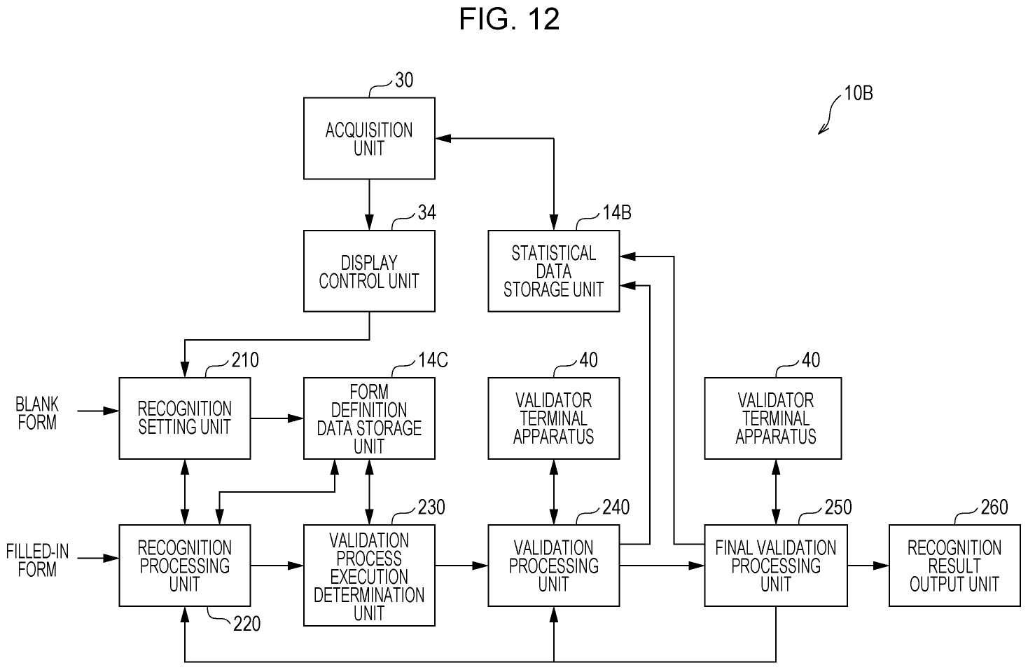

FIG. 12 is a block diagram illustrating an example functional configuration of a server apparatus 10B according to the second exemplary embodiment.

As illustrated in FIG. 12, a CPU 12A of the server apparatus 10B according to this exemplary embodiment functions as an acquisition unit 30 and a display control unit 34. The CPU 12A of the server apparatus 10B also functions as a recognition setting unit 210, a recognition processing unit 220, a validation process execution determination unit 230, a validation processing unit 240, a final validation processing unit 250, and a recognition result output unit 260. Components having functions similar to those of the server apparatus 10A according to the first exemplary embodiment described above are assigned the same numerals and will not be described repeatedly.

The storage unit 14 according to this exemplary embodiment includes the statistical data storage unit 14B that stores the statistical data illustrated in FIG. 5 described above, and the form definition data storage unit 14C that stores form definition data. The statistical data according to this exemplary embodiment includes the name of a recognition dictionary in association with the attribute of each frame. In this exemplary embodiment, the dictionary name is required.

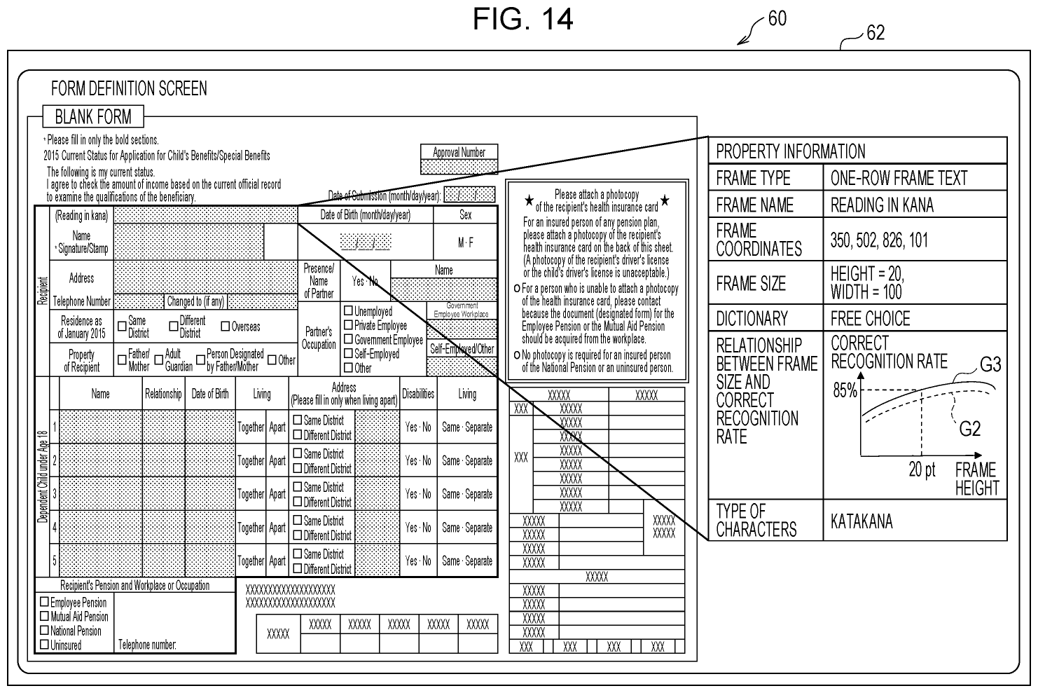

By way of example, as illustrated in FIG. 14 described below, the display control unit 34 performs control to display, for each recognition dictionary, a relationship between the size of the frame associated with the recognition dictionary and the correct recognition rate for the frame on the form definition screen 62.

Further, in response to receipt on the form definition screen 62 of a change in the recognition dictionary associated with a frame whose display style is changed from, the display control unit 34 may perform control to change the relationship described above in accordance with the change in the recognition dictionary.

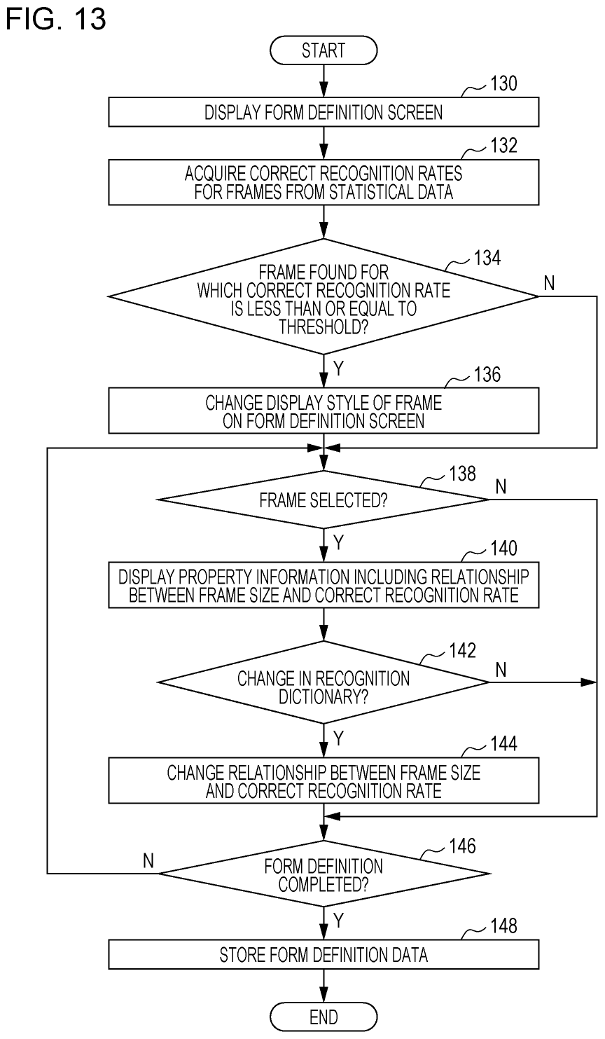

Next, the operation of the server apparatus 10B according to the second exemplary embodiment will be described with reference to FIG. 13.

FIG. 13 is a flowchart illustrating an example flow of a form setting process performed in accordance with the validation process program 14A according to the second exemplary embodiment.

First, when the server apparatus 10B is instructed to execute a form setting process, the validation process program 14A is started, and the following steps are executed.

In step 130 in FIG. 13, the CPU 12A, which serves as the recognition setting unit 210, displays the form definition screen 62 illustrated in FIG. 4 described above on the administrator terminal apparatus 60, by way of example.

In step 132, the CPU 12A, which serves as the acquisition unit 30, acquires correct recognition rates for the attributes of the frames from the statistical data illustrated in FIG. 5 described above, by way of example.

In step 134, the CPU 12A, which serves as the display control unit 34, determines whether a frame is found for which the correct recognition rate acquired in step 132 is less than or equal to a threshold. If it is determined that a frame is found for which the correct recognition rate is less than or equal to the threshold (if positive determination is obtained), the process proceeds to step 136. If it is determined that no frame is found for which the correct recognition rate is less than or equal to the threshold (if negative determination is obtained), the process proceeds to step 138.

In step 136, the CPU 12A, which serves as the display control unit 34, performs control to change the display style of the frame whose correct recognition rate is determined in step 134 to be less than or equal to the threshold on the form definition screen 62. The CPU 12A performs control to change the display styles of the frames in the form image in a different manner on the form definition screen 62 as illustrated in FIG. 8 described above in accordance with the correct recognition rates for the frames, by way of example.

In step 138, the CPU 12A, which serves as the display control unit 34, determines whether a frame is selected on the form definition screen 62 by the operation of the system administrator SE. If it is determined that a frame is selected (if positive determination is obtained), the process proceeds to step 140. If it is determined that no frame is selected (if negative determination is obtained), the process proceeds to step 146.

In step 140, by way of example, as illustrated in FIG. 9 described above, the CPU 12A, which serves as the display control unit 34, performs control to display property information of the frame selected in step 138, which includes the relationship between the size of the frame and the correct recognition rate for the frame, on the form definition screen 62.

In step 142, the CPU 12A, which serves as the display control unit 34, determines whether a change in the recognition dictionary for the frame whose property information is displayed in step 140 is receipt on the form definition screen 62 illustrated in FIG. 9 described above. If it is determined that a change in the recognition dictionary for the frame is received (if positive determination is obtained), the process proceeds to step 144. If it is determined that a change in the recognition dictionary for the frame is not received (if negative determination is obtained), the process proceeds to step 146.

In step 144, by way of example, as illustrated in FIG. 14, the CPU 12A, which serves as the display control unit 34, performs control to change the relationship between the size of the frame and the correct recognition rate for the frame in accordance with the change in the recognition dictionary for the frame. Here, by way of example, the recognition dictionary for the frame is changed to free choice. Note that the frame size is not changed.

FIG. 14 is a front view illustrating still another example of the form definition screen 62 according to this exemplary embodiment.

On the form definition screen 62 illustrated in FIG. 14, the recognition dictionary for the frame is changed from “katakana” to “free choice”. When the recognition dictionary for the frame is changed to “free choice”, the correct recognition rate is changed to 85%, that is, the graph itself is changed. In the example illustrated in FIG. 14, both a graph G2 before the change (dotted line) and a graph G3 after the change (solid line) are displayed to help understand the states before and after the change at a glance.

In step 146, the CPU 12A, which serves as the recognition setting unit 210, determines whether form definition is completed. If it is determined that form definition is completed (if positive determination is obtained), the process proceeds to step 148. If it is determined that form definition is not completed (if negative determination is obtained), the process returns to step 138, and the CPU 12A repeatedly performs the process.

In step 148, the CPU 12A, which serves as the recognition setting unit 210, stores the form definition data whose input is received on the form definition screen 62 in the form definition data storage unit 14C. Then, the form setting process according to the validation process program 14A ends.

In this exemplary embodiment, accordingly, when defining a form image, only by viewing a form definition screen at a glance, a user may identify in advance a frame whose content will be recognized with low accuracy due to the size of the frame. In addition, recognition accuracy may be improved by changing the recognition dictionary for the frame whose content will be recognized with low accuracy.

In the foregoing description, a server apparatus is used as an example of an information processing apparatus according to an exemplary embodiment. An exemplary embodiment may provide a program for causing a computer to execute the functions of the components of the server apparatus. An exemplary embodiment may provide a computer-readable non-transitory storage medium storing the program described above.

In addition, the configuration of the server apparatus provided in the exemplary embodiment described above is an example, and may be modified depending on the situation without departing from the spirit of the present disclosure.

In addition, the flow of the processes of the program provided in the exemplary embodiments described above is also an example. An unnecessary step may be deleted, a new step may be added, or the processing order may be changed without departing from the spirit of the present disclosure.

In the exemplary embodiments described above, furthermore, a program is executed to implement the processes according to the exemplary embodiments by a software configuration using a computer, by way of example but not limitation. The exemplary embodiments may be implemented by a hardware configuration or a combination of a hardware configuration and a software configuration, for example.

In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory; and
a processor connected to the memory and configured to
acquire correct recognition rates for frames corresponding to items contained in a form image from statistical data regarding results of recognition of images of contents of the frames, the statistical data including, in association with an attribute of each of the frames, a size of the frame and a correct recognition rate for the frame, the correct recognition rate indicating a percentage of correctly recognized images of contents of the frame, and
perform control to change a display style of a frame for which the acquired correct recognition rate is less than or equal to a threshold among the frames on a form definition screen, the form definition screen being a screen on which the form image is defined.

2. The information processing apparatus according to claim 1, wherein
the processor further performs control to display a relationship between the sizes of the frames and the correct recognition rates for the frames on the form definition screen, the relationship being derived from the statistical data.

3. The information processing apparatus according to claim 2, wherein
the processor further performs control to, in response to receipt on the form definition screen of a change in the size of the frame whose display style is changed, display relationships between the size of the frame and the correct recognition rate for the frame, the relationships being obtained before and after the change.

4. The information processing apparatus according to claim 1, wherein
the processor further performs control to change a display style of a nearby frame located near the frame whose display style is changed, when the correct recognition rate for the nearby frame is low, the nearby frame being a frame whose size decreases with an increase in the size of the frame whose display style is changed.

5. The information processing apparatus according to claim 1, wherein
the processor further performs control to change a display style of a frame having a smallest reduction in correct recognition rate among a plurality of frames other than the frame whose display style is changed, the plurality of frames being frames whose sizes decrease with an increase in the size of the frame whose display style is changed.

6. The information processing apparatus according to claim 2, wherein
the statistical data further includes recognition dictionaries in association with the attributes of the frames, and
the processor further performs control to display, for each of the recognition dictionaries, a relationship between the size of the frame associated with the recognition dictionary and the correct recognition rate for the frame on the form definition screen.

7. The information processing apparatus according to claim 6, wherein
the processor further performs control to, in response to receipt on the form definition screen of a change in the recognition dictionary associated with the frame whose display style is changed, change the relationship between the size of the frame and the correct recognition rate for the frame in accordance with the change.

8. The information processing apparatus according to claim 1, wherein
the processor further performs control to change display styles of the frames in the form image in a different manner on the form definition screen in accordance with the correct recognition rates for the frames.

9. The information processing apparatus according to claim 2, wherein
the processor further performs control to change display styles of the frames in the form image in a different manner on the form definition screen in accordance with the correct recognition rates for the frames.

10. The information processing apparatus according to claim 3, wherein
the processor further performs control to change display styles of the frames in the form image in a different manner on the form definition screen in accordance with the correct recognition rates for the frames.

11. The information processing apparatus according to claim 4, wherein
the processor further performs control to change display styles of the frames in the form image in a different manner on the form definition screen in accordance with the correct recognition rates for the frames.

12. The information processing apparatus according to claim 5, wherein
the processor further performs control to change display styles of the frames in the form image in a different manner on the form definition screen in accordance with the correct recognition rates for the frames.

13. The information processing apparatus according to claim 6, wherein
the processor further performs control to change display styles of the frames in the form image in a different manner on the form definition screen in accordance with the correct recognition rates for the frames.

14. The information processing apparatus according to claim 7, wherein
the processor further performs control to change display styles of the frames in the form image in a different manner on the form definition screen in accordance with the correct recognition rates for the frames.

15. A non-transitory computer readable medium storing a program causing a computer to execute a process for information processing, the process comprising:
acquiring correct recognition rates for frames corresponding to items contained in a form image from statistical data regarding results of recognition of images of contents of the frames, the statistical data including, in association with an attribute of each of the frames, a size of the frame and a correct recognition rate for the frame, the correct recognition rate indicating a percentage of correctly recognized images of contents of the frame, and
performing control to change a display style of a frame for which the acquired correct recognition rate is less than or equal to a threshold among the frames on a form definition screen, the form definition screen being a screen on which the form image is defined.

16. An information processing apparatus comprising:
means for acquiring correct recognition rates for frames corresponding to items contained in a form image from statistical data regarding results of recognition of images of contents of the frames, the statistical data including, in association with an attribute of each of the frames, a size of the frame and a correct recognition rate for the frame, the correct recognition rate indicating a percentage of correctly recognized images of contents of the frame, and
means for performing control to change a display style of a frame for which the acquired correct recognition rate is less than or equal to a threshold among the frames on a form definition screen, the form definition screen being a screen on which the form image is defined.
